(19) United States
(12) Patent Application Publication
(10) Pub. No.: US 2022/0131181 A1
(43) Pub. Date: Apr. 28, 2022

(54) METHOD FOR MANUFACTURING SOLID SECONDARY BATTERY INCLUDING COMPOSITE ELECTROLYTE FILM

(71) Applicant: ELECTRONICS AND TELECOMMUNICATIONS RESEARCH INSTITUTE, Daejeon (KR)

(72) Inventors: Dong Ok SHIN, Sejong (KR); Young-Gi LEE, Daejeon (KR); Myeong Ju LEE, Daejeon (KR); Seok Hun KANG, Daejeon (KR); Kwang Man KIM, Daejeon (KR); Jumi KIM, Daejeon (KR); Ju Young KIM, Sejong (KR); Jimin OH, Daejeon (KR)

(21) Appl. No.: 17/398,592

(22) Filed: Aug. 10, 2021

(30) Foreign Application Priority Data
Oct. 27, 2020 (KR) 10-2020-0140286

(51) Int. Cl. H01M 10/0562; H01M 4/04; H01M 10/052; H01M 10/44

(52) U.S. Cl. CPC H01M 10/0562; H01M 4/0407; H01M 2300/0071; H01M 10/44; H01M 10/052

(57) ABSTRACT

Provided is a method for manufacturing a solid secondary battery, wherein the method includes forming a composite electrolyte film, and forming a positive electrode and a negative electrode respectively on both surfaces of the composite electrolyte film. The forming of a composite electrolyte film includes preparing inorganic ion conductor powder coated with an ion resistance layer, removing the ion resistance layer to expose the surface of the inorganic ion conductor powder, mixing the inorganic ion conductor powder with an organic ion conductor and a solvent to prepare a composite electrolyte solution, and removing the solvent from the composite electrolyte solution.

### CROSS-REFERENCE TO RELATED APPLICATIONS

This U.S. non-provisional patent application claims priority under 35 U.S.C. § 119 of Korean Patent Application No. 10-2020-0140286, filed on Oct. 27, 2020, the entire contents of which are hereby incorporated by reference.

### BACKGROUND

The present disclosure herein relates to a method for manufacturing a solid secondary battery including a composite electrolyte film.

Compared to other batteries, a lithium secondary battery has a high energy density and can be made small and light, and thus, is highly likely to be used as a power source for a mobile electronic device and the like. The lithium secondary battery may include a positive electrode, a negative electrode, and an electrolyte. Typically, as a liquid electrolyte, a carbonate-based solvent in which a lithium salt (LiPF₆) is dissolved is used. A liquid electrolyte has a high mobility of lithium ions, and thus, exhibits excellent electrochemical properties. However, there is a problem in safety due to an explosion caused by the high flammability, volatility, and leakage of the liquid electrolyte.

Therefore, research is underway on a solid-state secondary battery using a solid electrolyte instead of a liquid electrolyte. A solid-state secondary battery may ensure stability and mechanical strength, and thus, is attracting attention in various application systems that require high stability, such as electric vehicles, energy storage systems, wearable devices, and the like.

### SUMMARY

The present disclosure provides a method for manufacturing a solid secondary battery including a solid electrolyte which has high ion conduction performance.

The problems to be solved by the inventive concept are not limited to the above-mentioned problems, and other problems that are not mentioned may be apparent to those skilled in the art from the following description.

An embodiment of the inventive concept provides a method for manufacturing a solid secondary battery, wherein the method includes forming a composite electrolyte film, and forming a positive electrode and a negative electrode respectively on both surfaces of the composite electrolyte film, wherein the forming of a composite electrolyte film may include preparing inorganic ion conductor powder coated with an ion resistance layer, removing the ion resistance layer to expose the surface of the inorganic ion conductor powder, mixing the inorganic ion conductor powder with an organic ion conductor and a solvent to prepare a composite electrolyte solution, and removing the solvent from the composite electrolyte solution.

In an embodiment, the carbon concentration of the inorganic ion conductor powder may be less than the carbon concentration of the ion resistance layer.

In an embodiment, the dielectric constant of the ion resistance layer may be smaller than the dielectric constant of the inorganic ion conductor powder.

In an embodiment, the removing of the ion resistance layer may include an isotropic etching process.

In an embodiment, the isotropic etching process may include at least one of a dry etching process and a wet etching process.

In an embodiment, the dry etching process may include at least one of a reactive ion etching and a gas phase etching process.

In an embodiment, before mixing the inorganic ion conductor powder with the organic ion conductor and the solvent, storing the inorganic ion conductor powder in a container in an inert gas atmosphere may further be included.

In an embodiment, the inorganic ion conductor powder may come into contact with the organic ion conductor.

In an embodiment, the composite electrolyte film may include the inorganic ion conductor powder at a ratio of greater than 0 w % to 80 w %.

In an embodiment, the inorganic ion conductor powder may include lithium lanthanum zirconium oxide (LLZO), and the ion resistance layer may include lithium carbonate (Li₂CO₃).

In an embodiment, the thickness of the composite electrolyte film may be 50 to 200 μm.

In an embodiment, the inorganic ion conductor powder may have a spherical shape, and the diameter of the inorganic ion conductor powder may be 50 nm to 50 μm, and the thickness of the ion resistance layer may be 10 nm to 100 nm.

In an embodiment, the preparing of inorganic ion conductor powder coated with an ion resistance layer may include forming inorganic ion conductor powder in the atmosphere, and the ion resistance layer may be formed as a result of the reaction between at least one among moisture, oxygen, and carbon dioxide in the atmosphere and the inorganic ion conductor powder.

In an embodiment, the forming of inorganic ion conductor powder may include a heat treatment process, and the ion resistance layer may be formed either during the heat treatment process or after the heat treatment process.

In an embodiment, the dielectric constant of the inorganic ion conductor powder may be 40 to 60, and the dielectric constant of the ion resistance layer may be 4 to 6.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1A is a flowchart showing a manufacturing process of a solid secondary battery;

FIG. 1B is a conceptual view showing a method for manufacturing a composite electrolyte film of a solid secondary battery;

FIG. 2 is a conceptual view of a solid secondary battery in accordance with the inventive concept;

FIG. 3 is a graph showing the surface of an inorganic ion conductor analyzed through Raman spectroscopy before and after an etching process is performed;

FIG. 4 is a graph showing the ratio of carbon/lanthanum (C/La) and carbon/zirconium (C/Zr) elements on the surface of an inorganic ion conductor during an etching process;

FIG. 5 is SEM shapes and analysis results of EDS-mapping before and after etching an ion resistance layer of inorganic ion conductor powder;

FIG. 6 is a graph showing the ion conductivity of Example, Comparative Example 1, and Comparative Example 2;

FIG. 7 is a graph showing the measurement of sheet resistance of Example and Comparative Example 1;

FIG. 8 is a graph showing the charging/discharging properties of solid secondary batteries respectively including Example and Comparative Example 1; and

FIG. 9 is a graph showing the lifespan of solid secondary batteries respectively including Example and Comparative Example 1.

### DETAILED DESCRIPTION

In order to facilitate sufficient understanding of the configuration and effects of the inventive concept, preferred embodiments of the inventive concept will be described with reference to the accompanying drawings. However, the inventive concept is not limited to the embodiments set forth below, and may be embodied in various forms and modified in many alternate forms. Rather, these embodiments are provided so that this disclosure will be thorough and complete, and will fully convey the scope of the inventive concept to those skilled in the art to which the inventive concept pertains. In the accompanying drawings, elements are illustrated enlarged from the actual size thereof for convenience of description, and the ratio of each element may be exaggerated or reduced.

Unless otherwise defined, terms used in the embodiments of the inventive concept may be interpreted as meanings commonly known to those skilled in the art. Hereinafter, embodiments of the inventive concept will be described with reference to the accompanying drawings to describe the inventive concept in detail.

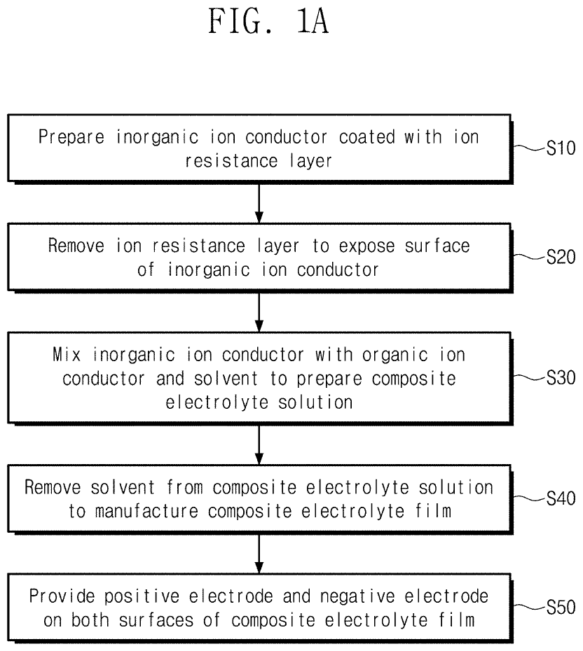

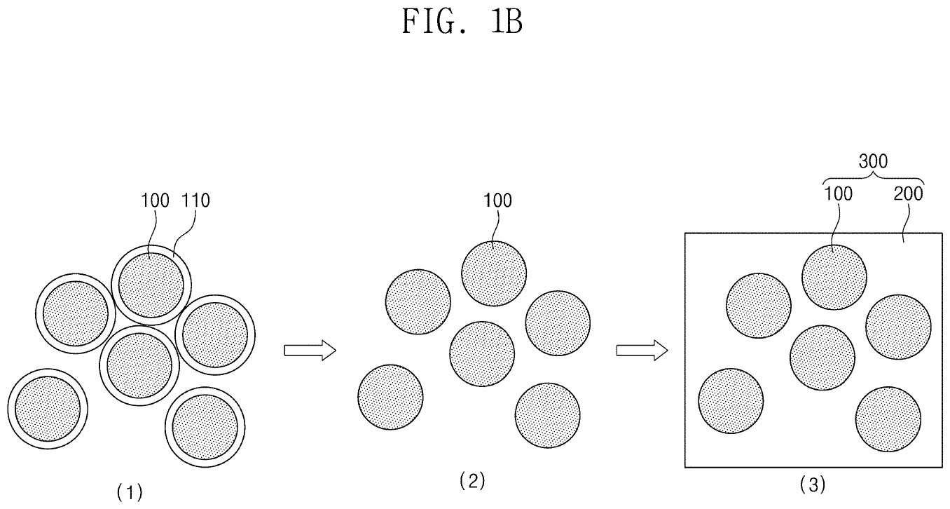

FIG. 1A is a flowchart showing a manufacturing process of a solid secondary battery. FIG. 1B is a conceptual view showing a method for manufacturing a composite electrolyte film of a solid secondary battery.

Referring to FIG. 1A and FIG. 1B, an inorganic ion conductor 100 coated with an ion resistance layer 100 is prepared (Step 1, S10). The ion resistance layer 110 may be formed during a manufacturing process of the inorganic ion conductor 100.

First, the inorganic ion conductor 100 may be provided in the form of powder having a spherical shape. The diameter of the inorganic ion conductor 100 may be 50 nm to 50 μm.

The inorganic ion conductor 100 may include at least one among oxide, phosphate, and sulfide solid electrolytes, or mixtures thereof.

The oxide solid electrolyte may include a material with a garnet-type structure or a material with a perovskite structure. The material with a garnet-type structure may include any one material among Li₅La₃M₂O₁₂ (M=Nb, Ta), Li₇La₃ZrO₁₂, Li₆BaLa₂Ta₂O₁₂, and the like. In addition, the Li₇La₃ZrO₁₂ may include Al, Ga, or the like at a ratio of 0 to 0.3 mol as a doping element instead of Li, and may include Nb, Ta, or the like at a ratio of 0 to 0.3 mol as a doping element instead of Zr. The material with a perovskite structure may include Li₃ₓLa_{(2/3)-x}^{□}_{(1/3)-2x}TiO₃ (LLTO, 0<x<0.16, □; avacancy).

The phosphate solid electrolyte may include a material with a NASICON structure of Li₁₊ₓAlₓTi₂₋ₓ(PO₄)₃ (x=0-0.4).

The sulfide solid electrolyte may include a chalcogenide element and lithium. The sulfide solid electrolyte may include any one of a material such as Li₁₀SnP₂S₁₂ and Li₄₋ₓSn₁₋ₓAsₓS₄ (x=0 to 100) in a Li_{10±1}MP₂X₁₂ (M=Ge, Si, Sn, Al or P, and X=S or Se) group, a material such as Li_{3.25}Ge_{0.25}P_{0.75}S₄ and Li₁₀GeP₂S₁₂ in a thio-lithium superionic conductor (thio-LISICON) group, a material such as Li₆PS₅Cl in a Li-argyrodite Li₆PS₅X (X=Cl, Br or I) group, a material such as a composition selected from a Li₂S.P₂S₅ (xLi₂S.(100−x)P₂S₅, x=0-100) group with a glass-ceramic structure, and a material such as Li₂.P₂S₅, Li₂S.SiS₂.Li₃N, Li₂S.P₂S₅.LiI, Li₂S.SiS₂.LiₓMO_{y}, Li₂S.GeS₂, Li₂S.B₂S₃.LiI in a group having a glass structure.

The inorganic ion conductor 100 may be synthesized in the form of powder. The inorganic ion conductor 100 may be manufactured through a solid phase method in which precursor powder is mixed and then heat treated to perform synthesis, or a solution process in which a precursor is dissolved in a solvent, dried, and then heat treated to perform synthesis.

During a formation process of the inorganic ion conductor 100, the ion resistance layer 110 may be formed on the surface thereof. The ion resistance layer 110 may be formed in the state of coating the surface of the inorganic ion conductor 100. The thickness of the ion resistance layer 110 may be less than the diameter of the inorganic ion conductor 100. The thickness of the ion resistance layer 110 may be 10 nm to less than 100 nm. As an example, the thickness of the ion resistance layer 110 may be 10 nm.

Between heat treatment processes or after a heat treatment process in the formation process of the inorganic ion conductor 100, atmospheric components such as moisture, oxygen, carbon dioxide, and the like may react with materials of the inorganic ion conductor 100, and as a result, the ion resistance layer 110 may be formed. As a result, the state of (1) in FIG. 1B may be achieved. The ion resistance layer 110 may include a carbon oxide as an example. The ion resistance layer 110 may be a material layer having high resistance to the flow of ions and having a low dielectric constant. The ion resistance layer 110 may have a smaller dielectric constant than the inorganic ion conductor 100.

As an example, the inorganic ion conductor 100 may include LLZO, and the dielectric constant of the inorganic ion conductor 100 may be 40 to 60. As an example, the ion resistance layer 110 may include Li₂CO—, and the dielectric constant of the ion resistance layer 110 may be 4 to 6. After the inorganic ion conductor 100 and an organic ion conductor 200 are mixed, which is to be described later, the ion resistance layer 110 may interfere with the dissociation of ions in the organic ion conductor 200.

Referring to FIG. 1A and FIG. 1B, the ion resistance layer 110 is removed to expose the surface of the inorganic ion conductor 100 (Step 2, S20), and as a result, the state of (2) of FIG. 1B may be achieved. The Step 2 S20 may include an etching process. The etching process may be an isotropic etching process.

The etching process may include a dry etching process or a wet etching process. The dry etching process may include a reactive ion etching process or a gas phase etching process.

As an example, in the reactive ion etching process, the ion resistance layer 110 may be etched using plasma accelerated by applying a voltage between two electrodes. The reactive ion etching process ideally has anisotropic etching properties, but may practically have some isotropic etching properties. As a result, during an etching process for an upper surface of the ion resistance layer 110, a side surface and a lower end of the ion resistance layer 110 may be etched. The type, flow rate, and applied voltage of a gas used at the time of etching may be adjusted to implement a fine etching process at a few nanometers per minute unit.

As another example, in the gas phase etching process, the ion resistance layer 110 may be etched using a highly corrosive material in a gaseous state. When the material in a gaseous state is introduced into an enclosed space, the ion resistance layer 110 on the surface of the inorganic ion conductor 100 may be etched.

In the wet etching process, the inorganic ion conductor 100 may be introduced to a solution in which etching components are dissolved. The solution in which etching components are dissolved may uniformly remove the ion resistance layer 110 on the surface of the inorganic ion conductor 100.

The inorganic ion conductor 100 from which the ion resistance layer 110 is removed may be stored in a container filled with an inert gas. The inert gas may include an argon gas as an example. The container may be a glove box as an example. The inorganic ion conductor 100 from which the ion resistance layer 110 is removed is stored in the container having the inert gas, and thus, may be prevented from reacting with moisture, oxygen, and carbon dioxide in the atmosphere.

Next, referring to FIG. 1A and FIG. 1B, the inorganic ion conductor 100 from which the ion resistance layer 110 is removed, the organic ion conductor 200, and a solvent may be mixed to prepare a composite electrolyte solution (Step 3, S30). Thereafter, the solvent is removed to manufacture a composite electrolyte film 300 (Step 4, S40). As a result, the state of (3) in FIG. 1B is achieved. The composite electrolyte film 300 may be formed through solution casting.

Specifically, a flat glass substrate is prepared. The composite electrolyte solution is poured on the glass substrate, and though a doctor blade process, a film having a predetermined thickness may be manufactured. The concentration of a polymer material, which is to be described later, with respect to the solvent may be 5 to 20 wt. As an example, when the concentration of the polymer material is 10 wt %, the thickness of the film may be about 80 μm to 120 μm. The solvent in the composite electrolyte solution forming the film is evaporated.

As the solvent is evaporated, the composite electrolyte film 300 may be formed. The composite electrolyte film 300 may be in a solid state. The composite electrolyte film 300 may be delaminated from the glass substrate. Instead of the glass substrate, a substrate including organic substances may be used. As an example, the organic substance substrate may be a Teflon substrate. The evaporation of the solvent of the composite electrolyte solution may be achieved through heat treatment at 60 to 120° C. for 6 to 24 hours. In an embodiment, an evaporation process may be performed in a vacuum state.

The organic ion conductor 200 may include a polymer material and a lithium salt.

The polymer material may include at least one among polyethylene oxide (PEO), polyvinyl chloride (PVC), polyacrylonitrile (PAN), poly(methyl methacrylate)(PMMA), polyvinylidene fluoride (PVDF), a polyvinylidene fluoride-hexafluoropropylene) (P(VDF-HFP)) copolymer, or mixtures thereof

The lithium salt may include at least one among LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, LiSCN, LiC(CF₃SO₂)₃, (CF₃SO₂)₂NLi, LiFSI, LiTFSI, LiBETI, LiBPB, LiCTFSI, LiTDI, or LiPDI.

The solvent may include a volatile solvent. Specifically, the organic ion conductor 200 may be prepared by dissolving a lithium salt in a volatile solvent capable of dissociating lithium ions, and then putting a polymer material thereto. The volatile solvent may include at least one among acentonitrile, butyronitrile, benzonitrile, dichloromethane, dimethylformamide, N-methyl-2-pyrrolidone (NMP),

Tetramethyl urea, Dimethyl Sulfoxide (DMSO), Triethyl phosphate (TEP), Acetone, Tetrahydrofuran (THF), Glycol Ethers, Cyclohexanone, Isophorone, or n-Butyl Acetate.

The molar ratio of the polymer material and the lithium salt may be between 5:1 and 30:1. According to an embodiment, the molar ratio of the polymer material and the lithium salt may be 5:1 to 10:1. The concentration of the polymer material with respect to the volatile solvent may be 5 wt % to 20 wt %. As an example, the concentration may be about 10 wt %.

The mixing ratio of the inorganic ion conductor 100 and the organic ion conductor 200 may be adjusted according to the weight ratio thereof. The content of the inorganic ion conductor 100 may be in the range of greater than 0 to 80 wt % based on the total composite electrolyte film 300.

According to the inventive concept, an etching process is performed before mixing the inorganic ion conductor 100 with the organic ion conductor 200, so that the ion resistance layer 110 on the inorganic ion conductor 100 may be removed. The ion resistance layer 110 has a low dielectric constant, and thus, when the inorganic ion conductor 100 and the organic ion conductor 200 are mixed, interferes the dissociation of ions between the two. The inventive concept removes the ion resistance layer 110 described above, so that the inorganic ion conductor 100 and the organic ion conductor 200 may come into contact with each other. The inorganic ion conductor 100 from which the ion resistance layer 110 is removed promotes the dissociation of ions at an interface with the organic ion conductor 200, and thus, may amplify the concentration of the ions. As a result, the ion conductivity of the composite electrolyte film 300 may increase.

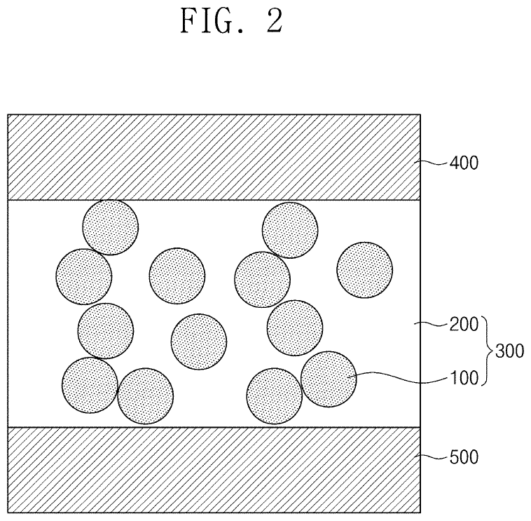

FIG. 2 is a conceptual view of a solid secondary battery in accordance with the inventive concept.

Referring to FIG. 1A, FIG. 1B, and FIG. 2, on both surfaces of the composite electrolyte film 300 in the state of (3) of FIG. 1B, a composite positive electrode 400 and a composite negative electrode 500 are provided (Step 5, S50). As a result, a solid secondary battery 1 of FIG. 2 may be manufactured. Step 5 S50 may be performed by performing a compression process with the composite electrolyte film 300 interposed between the composite positive electrode 400 and the composite negative electrode 500.

An interface contacting between the composite electrolyte film 300 and the composite positive electrode 400 and the composite negative electrode 500 may be formed by applying a pressure of 20 to 10 MPa on the composite electrolyte film 300. The composite positive electrode 400 and the composite negative electrode 500 may be spaced apart from each other with the composite electrolyte film 300 interposed therebetween.

The composite positive electrode 400 may include a positive electrode active material, a conductive material, and a binder. The composite negative electrode 500 may include a negative electrode active material, a conductive material, and a binder.

The positive electrode active material and the negative electrode active material may serve to store lithium ions.

The positive electrode active material may include a lithium cobalt oxide (LiCoO₂), a lithium nickel oxide (LiNiO₂), a lithium manganese oxide (LiMnO₄), a lithium nickel cobalt aluminum oxide (LiNiCoAlO₂), olivine (LiFePO₄), a lithium cobalt manganese nickel oxide (LiCoₓMn_{y}Ni_{z}O₂; x+y+z=1), mixtures thereof, or solid solutions thereof

The negative electrode active material may include carbon-based materials such as graphite, hard carbon, soft carbon, and the like, non-carbon-based materials such as tin, silicon, a lithium titanium oxide (LixTiO₂), a spinel lithium titanium oxide (Li₄Ti₅O₁₂), and the like, lithium and sodium metal foil or powder, and a composite of the non-carbon-based materials and graphite, graphene, or carbon nanotube.

The conductive material (electro-conducting agent) may serve to impart electronic conductivity to the composite positive electrode 400 and the composite negative electrode 500. The conductive material may include at least one among graphite, hard/soft carbon, carbon fiber, carbon nanotube, linear carbon, carbon black, acetylene black, or Ketjen black.

The binder (polymeric binder) may serve to fix active materials (the positive electrode active material and the negative electrode active material), and the conductive material. The binder may include polyvinylidene fluoride, polyimide, polytetrafluoroethylene, (poly(ethylene oxide)), polyacrylonitrile, hydroxypropyl cellulose, Carboxymethyl cellulose, Na-Carboxymethyl cellulose, Styrene-butadiene rubber, Nitrile-butadiene rubber, or mixtures thereof. According to an embodiment, the binder may be omitted.

The composite positive electrode 400 or the composite negative electrode 500 is manufactured through an application process of aslurry. Specifically, an active material (a positive electrode or a negative electrode), a conductive material (in the case of a composite positive electrode) are mixed according to a composition ratio, and a binder solution in which a binder is dissolved is added thereto, and then through a stirring process, a slurry is prepared. Thereafter, the slurry is applied on a metal foil, and through a drying process, a solvent in the binder solution is removed. Additionally, through a compression process, an electrode plate (a composite positive electrode or a composite negative electrode) is manufactured. The composition of the binder in the electrode may be 1 to 10 wt %.

The composition of the conductive material in the electrode may be 1 to 3 wt %. The loading level (Loading level=Active material content/Area) is determined by controlling the viscosity of the slurry, thickness at the time of coating, and pressure between 100 and 400 mPa applied at the time of a compression process. The higher the viscosity of the slurry, the greater the thickness at the time of coating, and the greater the compression pressure, the greater the loading level. The thickness of the electrode may be between 1 and 300 um.

### Example: Composite Electrolyte Film

An inorganic ion conductor is manufactured. An inorganic solid electrolyte of Li_{6.2}Al_{0.2}La₃Zr_{1.8}Ta_{0.2}O₁₂ (LALZTO) was synthesized through a solid phase method. Specifically, a lithium carbonate (Li₂CO₃, Alfa Aesar, 99.998%), a lanthanum(III) oxide (La₂O₃, Alfa Aesar, 99.99%), and a zirconium(IV) oxide (ZrO₂, Sigma Aldrich, 99%) were used as a precursor. An aluminum oxide (Al₂O₃, Sigma Aldrich) and a tantalum(V) oxide (Ta₂O₅, Sigma Aldrich, 99.99%) were used as a dopant. The precursor and the dopant were mixed with an isopropyl alcohol (IPA, Chemi Top, >99.9%) solvent for 6 to 12 hours using a planetary mill (Fritsch, Pulverisette 5) to prepare a slurry.

The slurry in which precursors were uniformly mixed was calcined at 1000 to 1200° C. for 4 to 24 hours to obtain cubic LALZTO solid electrolyte powder. The LALZTO solid electrolyte powder was pulverized through a ball milling process using a planetary micro mill (Fritsch, Pulverisette 7) to obtain high crystal cubic LALZTO solid electrolyte powder having a size of between 200 nm and 5 μm.

In order to remove an ion resistance layer naturally formed on the LALZTO solid electrolyte powder, the surface thereof was etched by a reactive-ion etching (RIE) method. The etching was performed by putting the LALZTO solid electrolyte powder into a reactive-ion etching device chamber.

An organic ion conductor is manufactured. Poly(vinylidene fluoride) (PVdF, Arkema, Solef® 5130, Molecular Weight 1,000,000-1,200,000), which is a polymer electrolyte, was prepared by a solution casting method.

10 wt % of PVdF was completely dissolved in a N,N-Dimethylformamide (DMF, Sigma Aldrich, 99.8%) solvent in which a lithium salt lithium perchlorate (LiClO₄, Sigma Aldrich, 99.99%) was dissolved to prepare a PVdF polymer electrolyte solution. A composite electrolyte film is manufactured. A PVdF-based composite electrolyte solution was prepared by adding the LALZTO solid electrolyte powder from which the ion resistance layer was removed to the PVdF polymer electrolyte solution in an amount of 30 wt % based on PVdF. The LALZTO solid electrolyte powder in the PVdF polymer electrolyte solution was uniformly dispersed through a precisely controlled mixing process. The prepared PVdF-based composite electrolyte solution was cast in a Teflon mold, and then dried in a vacuum oven at 40° C. for 12 hours and longer to evaporate the DMF solvent. A freestanding PVdF-based composite electrolyte (Thickness: 50 to 200 μm) film was obtained.

All of the electrolyte manufacturing processes were performed in a dry room or glove box where humidity was controlled.

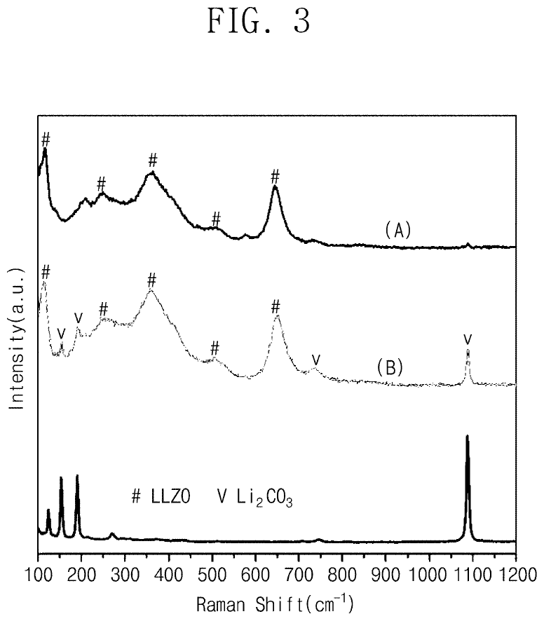

FIG. 3 is a graph showing the surface of an inorganic ion conductor analyzed through Raman spectroscopy before and after an etching process is performed.

Referring to FIG. 3, LLZO powder was prepared. Before the etching process, Li₂CO was observed, whereas after the etching process, Li₂CO₃ was not observed. It can be seen that an ion resistance layer including Li₂CO₃ on the surface of the LLZO powder was removed through the etching process.

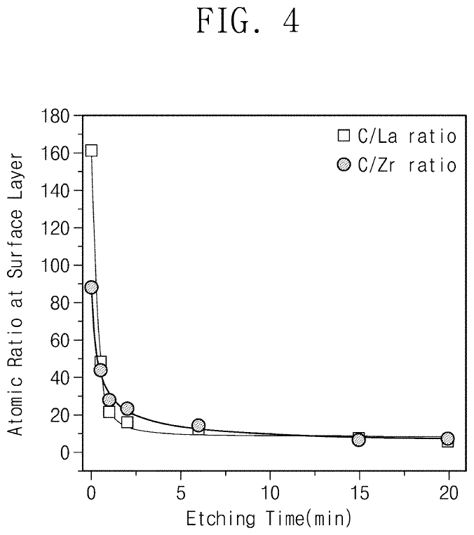

FIG. 4 is a graph showing the ratio of carbon/lanthanum (C/La) and carbon/zirconium (C/Zr) elements on the surface of an inorganic ion conductor during an etching process.

Referring to FIG. 4, LLZO powder was prepared. It can be seen that the ratio of carbon on the surface of the LLZO powder decreased as the etching process proceeded. It can be seen that an ion resistance layer including carbon on the surface of the LLZO powder was gradually removed through the etching process. The reason that the carbon/lanthanum and carbon/zirconium ratios were greater than 0 during the entire etching process was because carbon is naturally present on the surface.

FIG. 5 is SEM shapes and analysis results of EDS-mapping before and after etching an ion resistance layer of inorganic ion conductor powder. The etching process was performed on a silicon (Si) substrate. Before the etching process, an ion resistance layer including Li₂CO₃ was coated on the surface of the LLZO powder, so that carbon (C) and lanthanum (La), and zirconium (Zr) were observed. After the etching process, lanthanum (La) and zirconium (Zr) were observed, whereas Carbon (C) was not observed.

### Comparative Example 1

A composite electrolyte film was manufactured in the same manner as in Example except that Li_{6.75}Al_{0.2}La₃Zr_{1.75}Ta_{0.25}O₁₂(LALZTO) from which an ion resistance layer was not removed was used in Comparative Example 1.

### Comparative Example 2

An electrolyte film was manufactured in the same manner as in Example except that the electrolyte film was manufactured only with an organic ion conductor without adding an inorganic solid electrolyte in Comparative Example 2.

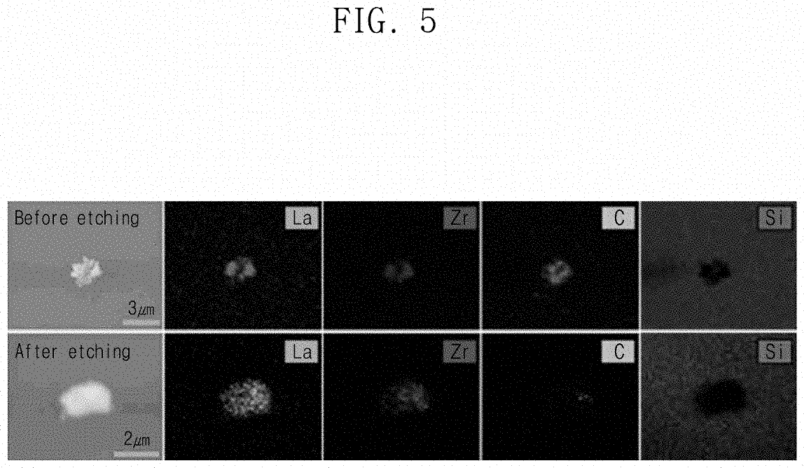

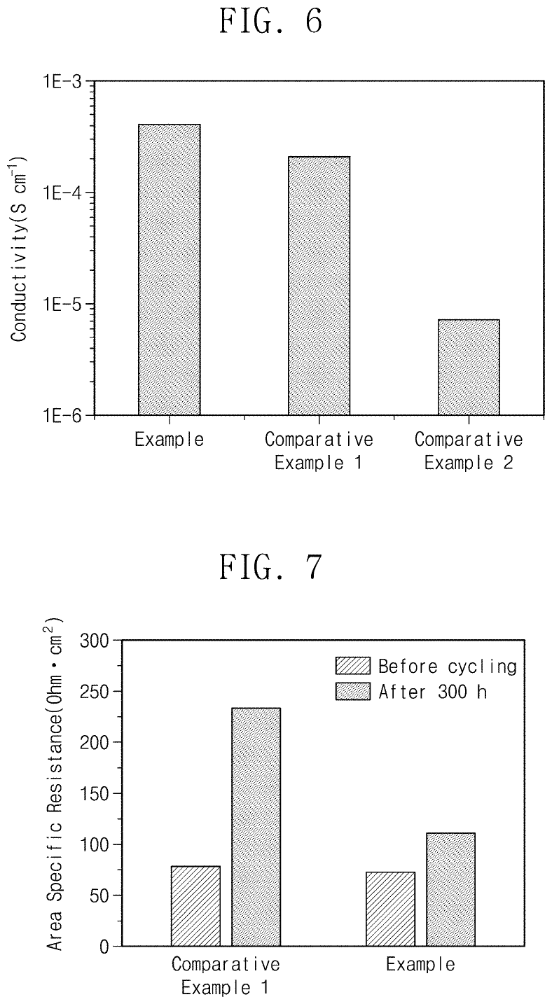

FIG. 6 is a graph showing the ion conductivity of Example, Comparative Example 1, and Comparative Example 2.

Referring to FIG. 6, ion conductivity measuring cells each composed of SUS/solid electrolyte film/SUS were manufactured respectively using Example, Comparative Example 1, and Comparative Example 2 as a solid electrolyte film. Using a frequency response analyzer (Solartron HF 1225), alternating current impedance was applied in the range of 10⁻¹ to 10⁵ Hz to measure ion conductivity. A resistance value was obtained from an impedance curve, and an ion conductivity value was obtained in units of S/cm from an equation of thickness/(resistance×width). The obtained value of Example was 4.05×10⁻⁴ S/cm, and the obtained values of Comparative Example 1 and Comparative Example 2 were 2.12×10⁻⁴ S/cm and 7.08×10⁻⁶ S/cm, respectively. That is, it can be seen that the ion conductivity of each of Comparative Example 1 and Comparative Example 2 was lower than that of Example. Particularly, the ion conductivity of Comparative Example 1 in which an etching process was not performed was lower than that of Example in which an etching process was performed. It can be seen that ion conductivity increases through the removal of an ion resistance layer on an inorganic ion conductor.

FIG. 7 is a graph showing the measurement of sheet resistance of Example and Comparative Example 1.

Referring to FIG. 7, sheet non-resistance measuring cells each composed of Li electrode/solid electrolyte film/Li electrode were manufactured respectively using Example and Comparative Example 1 as a solid electrolyte film. First, after the cells were manufactured, using a frequency response analyzer, alternating current impedance was applied in the range of 10⁻¹ to 10⁵ Hz to measure sheet non-resistance before charging/discharging. The charging/discharging was performed with a current density of 0.1 mA/cm². At this time, a current was applied for 300 hours alternating (+) and (−) in 1 hour increments. Next, using the frequency response analyzer again, alternating current impedance was applied in the range of 10⁻¹ to 10⁵ Hz to measure sheet non-resistance after charging/discharging. In the case of Example, the sheet non-resistance was increased from 72.5Ω cm² to 110Ωcm², whereas in the case of Comparative Example 1, the sheet non-resistance was greatly increased from 78Ω cm² to 232.5Ω cm² compared to Example. That is, it can be seen that the sheet non-resistance of Example increases less than that of Comparative Example 1 before and after charging/discharging.

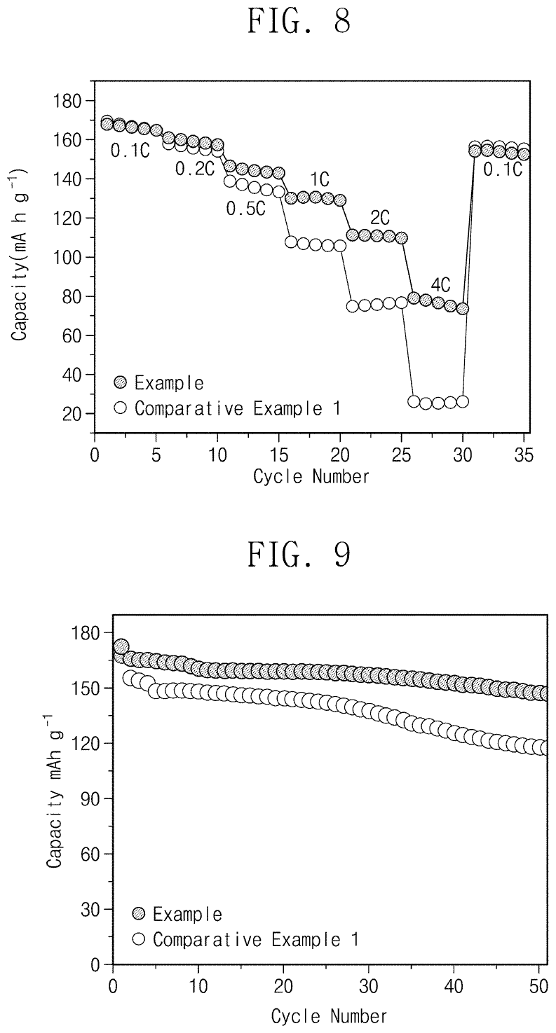

FIG. 8 is a graph showing the charging/discharging properties of solid secondary batteries respectively including Example and Comparative Example 1.

Referring to FIG. 8, solid secondary battery cells each composed of NCM622 composite positive electrode/solid electrolyte film/lithium metal were assembled respectively using Example and Comparative Example 1 as a solid electrolyte film.

In order to analyze the charging/discharging properties of the solid secondary battery cells according to Example and Comparative Example 1, charging/discharging was performed at room temperature while controlling the current density at a 0.1 to 4 C-rate in a voltage range of 3.0 to 4.3 V. From the measurement results, it can be seen that the charging/discharging speed of Example was faster than that of Comparative Example 1.

FIG. 9 is a graph showing the lifespan of solid secondary batteries respectively including Example and Comparative Example 1. Referring to FIG. 9, solid secondary battery cells each composed of composite positive electrode/solid electrolyte film/lithium metal were manufactured respectively using Example and Comparative Example 1 as a solid electrolyte film. The composite positive electrode was manufactured to include NCM622(LiNi_{0.6}Co_{0.2}Mn_{0.2}O₂). As for the composite positive electrode, As for the positive electrode, an NCM622 active material, a carbon black conductive material, and a PVdF polymer electrolyte solution was quantified at a weight ratio of 92:4:4 in a 1-Methyl-2-pyrrolidinone (NMP, Sigma Aldrich, 99.5%) solvent. Thereafter, a uniform solution was prepared using a mixer. The solution was coated on an aluminum foil using a doctor blade, and then dried in a vacuum oven at 60° C. for 24 hours and longer. The loading level of the composite positive electrode was controlled to 2 to 5.0 mg cm⁻². From the measurement results, it can be seen that the charging/discharging properties of Example were better than the charging/discharging properties of Comparative Example 1, and that Example had a better cycle lifespan of the solid secondary battery.

A method for manufacturing a solid secondary battery according to the inventive concept may increase ion conductivity in a composite electrolyte film through an etching process performed on the surface of inorganic ion conductor during a process of forming the composite electrolyte film.

Although the present invention has been described with reference to the accompanying drawings, it will be understood by those having ordinary skill in the art to which the present invention pertains that various changes in form and details may be made therein without departing from the spirit and scope of the present invention. Therefore, it is to be understood that the above-described embodiments are exemplary and non-limiting in every respect.

What is claimed is:

1. A method for manufacturing a solid secondary battery, the method comprising:
forming a composite electrolyte film; and
forming a positive electrode and a negative electrode respectively on both surfaces of the composite electrolyte film,
wherein the forming of a composite electrolyte film includes:
preparing inorganic ion conductor powder coated with an ion resistance layer;
removing the ion resistance layer to expose the surface of the inorganic ion conductor powder;
mixing the inorganic ion conductor powder with an organic ion conductor and a solvent to prepare a composite electrolyte solution; and
removing the solvent from the composite electrolyte solution.

2. The method of claim 1, wherein the carbon concentration of the inorganic ion conductor powder is less than the carbon concentration of the ion resistance layer.

3. The method of claim 1, wherein the dielectric constant of the ion resistance layer is smaller than the dielectric constant of the inorganic ion conductor powder.

4. The method of claim 1, wherein the removing of the ion resistance layer comprises an isotropic etching process.

5. The method of claim 4, wherein the isotropic etching process comprises at least one of a dry etching process and a wet etching process.

6. The method of claim 5, wherein the dry etching process comprises at least one of a reactive ion etching and a gas phase etching process.

7. The method of claim 1, further comprising, before mixing the inorganic ion conductor powder with the organic ion conductor and the solvent, storing the inorganic ion conductor powder in a container in an inert gas atmosphere.

8. The method of claim 1, wherein the inorganic ion conductor powder comes into contact with the organic ion conductor.

9. The method of claim 1, wherein the composite electrolyte film comprises the inorganic ion conductor powder at a ratio of greater than 0 w % to 80 w% .

10. The method of claim 1, wherein the inorganic ion conductor powder comprises lithium lanthanum zirconium oxide (LLZO), and the ion resistance layer comprises lithium carbonate (Li₂CO₃).

11. The method of claim 1, wherein the thickness of the composite electrolyte film is 50 to 200 μm.

12. The method of claim 1, wherein the inorganic ion conductor powder has a spherical shape, and the diameter of the inorganic ion conductor powder is 50 nm to 50 μm, and the thickness of the ion resistance layer is 10 nm to 100 nm.

13. The method of claim 1, wherein the preparing of inorganic ion conductor powder coated with an ion resistance layer comprises forming inorganic ion conductor powder in the atmosphere, and the ion resistance layer is formed as a result of the reaction between at least one among moisture, oxygen, and carbon dioxide in the atmosphere and the inorganic ion conductor powder.

14. The method of claim 13, wherein the forming of inorganic ion conductor powder comprises a heat treatment process, and the ion resistance layer is formed either during the heat treatment process or after the heat treatment process.

15. The method of claim 1, wherein the dielectric constant of the inorganic ion conductor powder is 40 to 60, and the dielectric constant of the ion resistance layer is 4 to 6.
